(19) United States
(12) Patent Application Publication
(10) Pub. No.: US 2025/0111345 A1
(43) Pub. Date: Apr. 3, 2025

(54) TIME-LOCKED KEY HIERARCHY FOR SELF-EXECUTING CRYPTOCURRENCY CONTRACT

(71) Applicant: AnchorWatch, Inc., Raleigh, NC (US)

(72) Inventors: Robert Hamilton, Knightdale, NC (US); Becca Rubenfeld, Seattle, WA (US)

(21) Appl. No.: 18/898,021

(22) Filed: Sep. 26, 2024

Related U.S. Application Data
(60) Provisional application No. 63/541,357, filed on Sep. 29, 2023.

(51) Int. Cl. G06Q 20/06; G06Q 20/38; G06Q 20/40

(52) U.S. Cl. CPC G06Q 20/065; G06Q 20/3829; G06Q 20/401

(57) ABSTRACT

A method of executing a cryptocurrency transaction includes receiving a cryptocurrency transaction instruction to execute a cryptocurrency transaction, the instruction including at least one key associated with at least one authorized keyset. It is next determined whether a transaction time of the cryptocurrency transaction instruction is in at least one of a plurality of predetermined time periods, each corresponding to a predetermined subset of authorized keysets of a plurality of predetermined subsets of authorized keysets. It is also determined whether the at least one key in the transaction instruction includes at least one key from each keyset of the predetermined subset of authorized keysets for the predetermined time period. The cryptocurrency transaction is executed only in response a determination that the at least one key in the transaction instruction includes at least one key from each keyset of the predetermined subset of authorized keysets for the predetermined time period.

### CROSS-REFERENCE TO RELATED APPLICATIONS

This application claims priority to U.S. Provisional Patent Application No. 63/541,357, filed on Sep. 29, 2023, the entirety of which is incorporated by reference herein.

### BACKGROUND

Embodiments relate to automatic implementation of cryptocurrency contracts, particularly to a locked key hierarchy for self-executing cryptocurrency contracts, and related devices, systems, and methods.

Cryptocurrency assets may be independently insured in a variety of ways. For example, cryptocurrency sums may be transferred to a cryptocurrency vault, and a term insurance contract may be put in place establishes differing levels of authority to access the stored cryptocurrency for different parties. Accordingly, there is a need for security measures to ensure that only the authorized parties have access to the cryptocurrency in the vault at any given time.

### SUMMARY

According to some embodiments, a system includes at least one processor circuit and at least one memory comprising machine-readable instructions. When executed by the at least one processor circuit, the instructions cause the at least one processor circuit to execute a first cryptocurrency transaction to transfer a cryptocurrency sum to a cryptocurrency vault, the cryptocurrency vault comprising a plurality of predetermined subsets of a plurality of authorized keysets, each keyset comprising at least one key. The instructions further cause the processor circuit to receive a cryptocurrency transaction instruction to execute a second cryptocurrency transaction to transfer at least a portion of the cryptocurrency sum out of the cryptocurrency vault, the cryptocurrency transaction instruction comprising at least one key associated with at least one authorized keyset of the plurality of authorized keysets. The instructions further cause the processor circuit to determine whether a transaction time of the cryptocurrency transaction instruction is in at least one predetermined time period of a plurality of predetermined time periods, each predetermined subset corresponding to a predetermined subset of authorized keysets of a plurality of predetermined subsets of the plurality of authorized keysets. The instructions further cause the processor circuit to determine whether the at least one key in the transaction instruction comprises at least one key from each keyset of the predetermined subset of authorized keysets corresponding to the at least one predetermined time period. The instructions further cause the processor circuit to, in response a determination that the at least one key in the transaction instruction comprises at least one key from each keyset of the predetermined subset of authorized keysets corresponding to the at least one predetermined time period, execute the second cryptocurrency transaction.

According to some embodiments, a method includes receiving, by at least one processor circuit, a cryptocurrency transaction instruction to execute a cryptocurrency transaction to transfer at least a portion of the cryptocurrency sum out of a cryptocurrency vault, the cryptocurrency transaction instruction comprising at least one key associated with at least one authorized keyset of a plurality of authorized keysets. The method further includes determining, by the processor circuit, whether a transaction time of the cryptocurrency transaction instruction is in at least one predetermined time period of a plurality of predetermined time periods, each predetermined subset corresponding to a predetermined subset of authorized keysets of a plurality of predetermined subsets of the plurality of authorized keysets. The method further includes determining, by the processor circuit, whether the at least one key in the transaction instruction comprises at least one key from each keyset of the predetermined subset of authorized keysets corresponding to the at least one predetermined time period. The method further includes executing, by the processor circuit, the cryptocurrency transaction only in response a determination that the at least one key in the transaction instruction comprises at least one key from each keyset of the predetermined subset of authorized keysets corresponding to the at least one predetermined time period.

According to some embodiments, a non-transitory computer readable medium comprising machine readable instructions that, when executed by at least one processor circuit, cause the at least one processor circuit to receive a cryptocurrency transaction instruction to execute a cryptocurrency transaction to transfer at least a portion of the cryptocurrency sum out of a cryptocurrency vault, the cryptocurrency transaction instruction comprising at least one key associated with at least one authorized keyset of a plurality of authorized keysets. The instructions further cause the processor circuit to determine whether a transaction time of the cryptocurrency transaction instruction is in at least one predetermined time period of a plurality of predetermined time periods, each predetermined subset corresponding to a predetermined subset of authorized keysets of a plurality of predetermined subsets of the plurality of authorized keysets. The instructions further cause the processor circuit to determine whether the at least one key in the transaction instruction comprises at least one key from each keyset of the predetermined subset of authorized keysets corresponding to the at least one predetermined time period. The instructions further cause the processor circuit to, in response a determination that the at least one key in the transaction instruction comprises at least one key from each keyset of the predetermined subset of authorized keysets corresponding to the at least one predetermined time period, execute the second cryptocurrency transaction.

### BRIEF DESCRIPTION OF THE DRAWINGS

FIG. 1 illustrates a Bitcoin block header, according to some embodiments.

FIG. 2 is a flowchart of operations for a blockchain transaction according to some embodiments.

FIG. 3 is a graphical timeline of time periods for an insurance policy term and a period following expiration of the policy and associated time locked authentication layers, according to some embodiments.

FIG. 4 is a schematic diagram of a computer system for implementing embodiments disclosed herein, according to some embodiments.

### DETAILED DESCRIPTION

Embodiments include the use of cryptocurrency smart contracts to allow a distribution of custody across multiple institutions, with rules automatically governing subsequent cryptocurrency transactions based on an insurance policy term or other agreement. In some examples, time locks with automatic timestamp verification may be used to restrict cryptocurrency transactions during different time periods specified by the policy. For example, during a policy term, the cryptocurrency may not be spendable without the explicit consent and cryptographic sign off by an insurer. After the insurance policy expires, different spending conditions may be offered such that reduced restrictions may remain in place after the policy lapses, e.g., during a compliance period, after which an insured customer regains full control of the funds.

In some examples, a multi-key coordinating software may provide programmatic compliance and redundant layers of cryptocurrency security. For example, by combining programmable security features with a cryptocurrency having a secure core code, such as Bitcoin for example, programmable security features may be provided that are well-suited for insurance and other applications. One suitable scripting language is miniscript, which is a language for writing a subset of Bitcoin scripts in a structured way, and which may allow for programmable spending conditions configurable into a vault with key hierarchies and time locks.

In a key hierarchy, specific signing keys associated with different parties may be assigned seniority within a vault, providing the insured and/or insurer more control over the cryptocurrency in the vault while still distributing risks among different parties and stakeholders. For example, a multi-key wallet may allow any minimum number of keys to sign a transaction (such as any two of three available keys). These keys may each be associated with a different individual, i.e., signer, such that a group or organization can maintain ownership and control of the vault, or the keys may all be associated with the same individual, such that an owner can separately manage access to the keys, thereby reducing the chance that an unauthorized person can gain access to the vault.

While this arrangement may be suitable for securing cryptocurrency for an individual or between multiple institutions collaboratively, i.e., on equal business and/or legal footing, this may be less suitable for arrangements where different parties and stakeholders may have different interests and contractual obligations. To address this problem, in some embodiments, different combinations of required keys may be specified, such as a first specific key and any one of the remaining two keys for a three-key vault. This provides heightened security around specific keys, and may elevate the security profile of the entire vault as a result.

Time locks may refer to the ability to restrict the spending of cryptocurrency to only be permitted if certain conditions are met, e.g. before, during, and/or after a specified time or time period. For example, by giving seniority to the first key in the above example, there is a risk that the cryptocurrency may become permanently locked and/or inaccessible if a specific signing device carrying the key is damaged or lost. To mitigate this risk, a time locked spending condition may be added in which after a different combination of signing devices may approve a transaction after a predetermined amount of time has passed. This may also allow for increased efficiency in the commencement and expiration of insurance and other time-based financial arrangements, with access to the cryptocurrency being managed automatically on a predetermined schedule.

By combining time locks, layered vaults (i.e., vaults with multiple authentication layers as discussed in greater detail below), and a distribution of required key keysets in different configurations and hierarchies, parties to an insurance or other transaction may mitigate against many different risks at once. For example, an insurer may be a required key holder, i.e., signatory, for the duration of a policy, with time locks and signatory requirements being pre-programmed into a vault in a way that cannot be changed unilaterally by the insured. In this manner, the insurer may withhold approval for cryptocurrency transactions until after the insurer and insured have completed their compliance procedures, thereby allowing the insurer to establish compliance minimums for every cryptocurrency transaction involving an insured vault.

As a result, the insurer may be a “negative control” signatory, i.e., the insurer is a required party to any attempted transaction, but the insurer may lack the authority to initiate a transaction or unilaterally control the cryptocurrency itself. In this manner, the insured is also protected against misuse of the insured cryptocurrency by the insurer, which only has the ability to prevent transactions (e.g., malicious or fraudulent transactions) by refusing to sign the transaction but does not have the ability to perform any transaction that is not authorized by the insured and/or a neutral third party, as may be specified by the policy. Conversely, once the insurer is able to validate transaction legitimacy, e.g., through compliance due diligence, the insurer can then sign the transaction.

In some examples, conditions may be set such that the insurer may recover locked funds in coordination with a third party, e.g., an additional approved institution such as a re-insurer, or another pre-selected recovery key holder (who also never has “positive control”, i.e., having authority to unilaterally initiate a transaction and/or control the cryptocurrency). For example, in a catastrophe scenario where the insured has lost all of their keys and/or signing devices, the insurer may be authorized to coordinate with the third party to recover the funds on behalf of the customer without any of the customer keys (e.g., after following appropriate compliance and due diligence procedures). Thus, different conditions may be set in different combinations to allow the insurer to mitigate customer risk, to spread the sole-custodian risk across multiple institutions and/or custodians, to protect the insurer against liability for unauthorized and/or fraudulent transactions involving insured funds, etc.

In some examples, when a policy expires, the insured may have the option to pay to renew the policy, which may include the key holders completing a self-send, i.e., moving the cryptocurrency from the current vault to a new vault with a new term and appropriate time locks. Alternatively, the insured may allow their coverage to lapse, at which point the insured regains full control of their funds. In some examples, a claims window may be provided after the policy expires but before the insured regains full control. For example, the insurer may remain as a required signatory during the claims window, i.e., during a period after the policy where the insurer retains some liability. After the claims window expires, the programmatic requirement that the insurer sign a transaction is removed automatically, and a new spending condition may become available that doesn't require the insurer's approval or involvement at all.

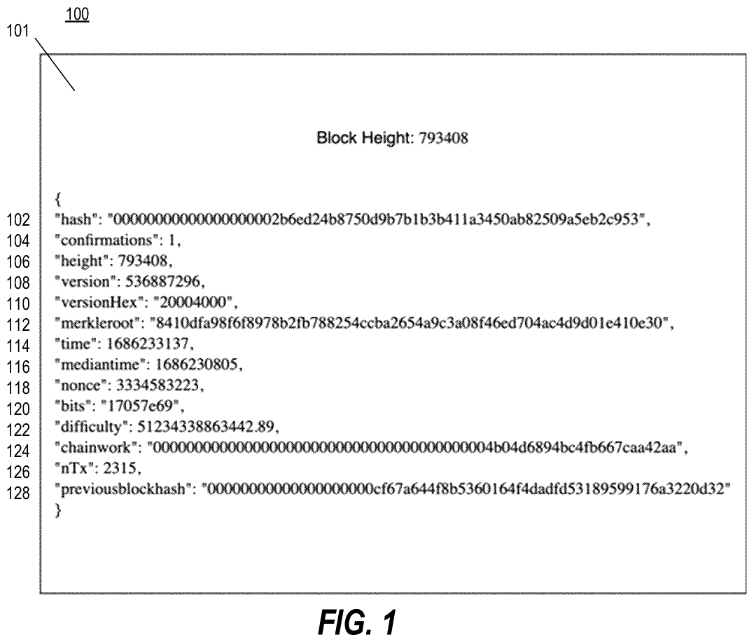

Referring now to FIG. 1, an example of a Bitcoin block header record 101 for a Bitcoin block 100 is illustrated. While many of the examples described herein employ and relate to Bitcoin, it should be understood that other types of cryptocurrency and/or blockchain technologies, e.g., Ethereum, USD Coin, etc., may be used with features disclosed herein. In some examples, some or all of the information in the block header record 101 may be recorded from the block 100 itself. Some information relating to the block 100 in the block header record 101 may also be inferred or derived from the block 100 and/or from other criteria, such as timestamps and other criteria associated with a Bitcoin node processing the block 100, and may not be stored in the block 100 itself, as desired.

In this example, hash 102 is the identifier for the block 100, calculated by a hash function of all the other data in the block. Confirmations 104 refers to the number of blocks that have been added to the blockchain since the block was added. A larger number of confirmations 104 indicates a higher level of confidence in the integrity and security of the block 100. Height 106 refers to a position of the block 100 in the blockchain. The block 100 is the 793408th block in the blockchain in this example.

Version 108 refers to the version number of the block structure. For example, developers may update the block structure in future versions of Bitcoin (or other blockchain technologies). versionHex 110 is a hexidecimal representation of version 108. Merkleroot 112 refers to the rook of the Merkle tree, which is a data structure that summarizes all of the transactions in the block 100.

Time 114 is the timestamp for the block 100, referring to the time when the block 100 was mined. In this example, time 114 is a Unix timestamp, i.e., the number of seconds that have elapsed since 00:00:00 Thursday, 1 Jan. 1970. Mediantime 116 refers to the median time of the 11 blocks preceding this block 100, which makes it more difficult to manipulate the time 114 value. The blockchain is maintained across thousands of different nodes, i.e., independently operated computing devices, which may not be perfectly synchronized, and which may result in timestamp discrepancies. To address this issue, mediantime 116 represents a reasonable time window for accepting timestamps from new blocks that may not be perfectly in sync. For example, if the time 114 value is before the mediantime 116 value, i.e., before the median time of the previous 11 blocks, this may indicate that the time 114 value has been manipulated and the block will be rejected and not added to the blockchain by other nodes. Any new time 114 value that is more than two hours after the time of the receiving node may also be rejected, because this may also indicate manipulation of the time 114 value. If the time value 114 is after the mediantime 116 value and less than two hours after the time of the receiving node, this may indicate that the time 114 value of the block 100 is trustworthy, as it relates to the timestamp.

Nonce 118 is a random number that miners change when mining new blocks. The nonce 118 is input into the hash function in an attempt to meet a difficulty target. Bits 120 is a compact representation of the number in hexadecimal form in which the hash of a block must be below to be a valid block. When a nonce 118 is provided as an input into the hash function, it generates a hash 102, then compared to the bits 120. If the hash 102 is less than the bits 120 (represented as a decimal integer in with difficulty 122), block 100 is mined and added to the blockchain, assuming all other consensus rules are followed for the network. Otherwise, no block is mined, and a miner inputs a new nonce 118 into the hash function. Difficulty 122 is a number indicating the threshold of what the block hash 102 must be less than to be valid.

Chainwork 124 is an estimated amount of hashes to make this block. This can be compared to other blocks in the blockchain to verify the integrity and security of the block 100. nTx 126 refers to the number of transactions included in the block 100. Finally, previousblockhash 128 is the hash of the previous block in the blockchain, which is used to link blocks together into a continuous chain.

As noted above, the block 100 itself may contain a subset of these elements, such as previousblockhash 128, merkleroot 112, time 114, nonce 118, version 108, and/or bits 120, for example.

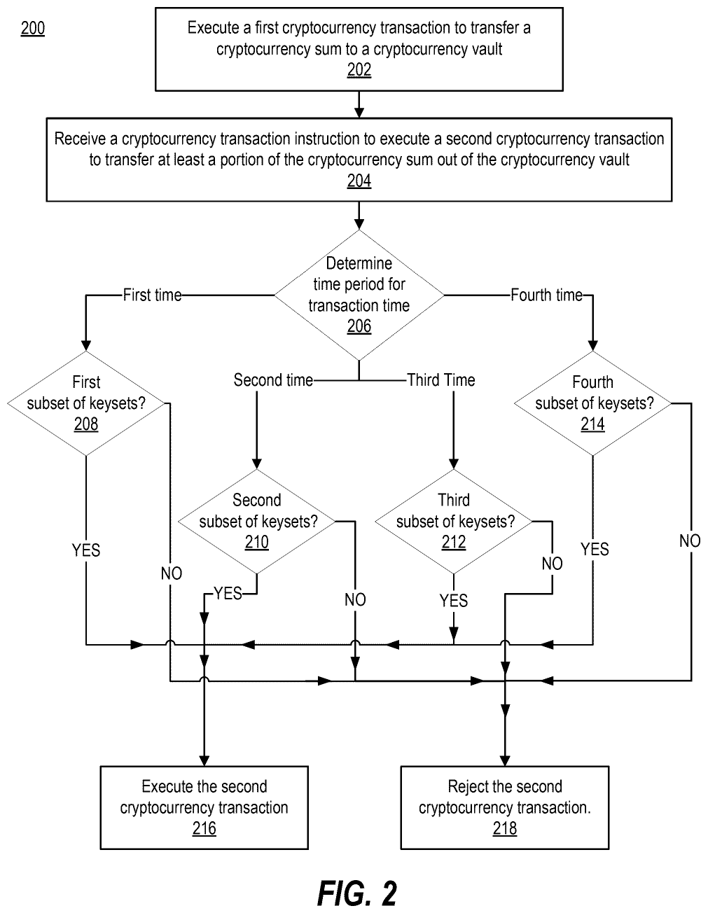

FIG. 2 is a flowchart diagram of operations 200 for a blockchain transaction according to some embodiments. The operations 200 may include executing a first cryptocurrency transaction to transfer a cryptocurrency sum to a cryptocurrency vault with a plurality of predetermined subsets of a plurality of authorized keysets (Block 202). In some examples, the cryptocurrency vault may comprise a financial account, such as a deposit account, investment account, and/or escrow account, etc., a trust, and/or an estate, etc. As discussed above, the cryptocurrency sum may comprise Bitcoin, Ethereum, and/or any other cryptocurrency sum, as desired.

As used herein, keyset refers to a group or category of one or more keys that may be used interchangeably with each other. For example, a customer keyset may include three unique customer keys. As used herein, providing a keyset refers to providing a predetermined minimum number of keys of the keyset. For example, the customer keyset in the above example may be provided by providing any one or the three unique customer keys, any two of the three customer keys, or all three of the customer keys, as desired. The keysets and keyset provision criteria may be independently configured for different time periods and conditions, as desired. As used herein, key may refer to an alphanumeric text string or other input for authenticating a transaction. Examples of keys may include a pre-image and corresponding hash, a point on an elliptic curve, an alphanumeric password, passphrase, code, 256 bit number or other number, etc. A key may be software based, e.g., stored in a memory, generated by a processor circuit, etc., and/or hardware-based, e.g., accessible using a hardware dongle, physical key hardware, or other physical item, as desired.

The operations 200 may further include receiving a cryptocurrency transaction instruction to execute a second cryptocurrency transaction to transfer at least a portion of the cryptocurrency sum out of the cryptocurrency vault (Block 204). The cryptocurrency transaction instruction may include at least one key associated with at least one authorized keyset of the plurality of authorized keysets. For example, the authorized keysets may include at least one customer keyset associated with a customer, at least one custodian keyset associated with a custodian of the cryptocurrency vault, and at least one third party keyset associated with a third-party. For example, the customer may include an insured owner of the cryptocurrency sum, a beneficiary of a trust comprising the cryptocurrency sum, a beneficiary of an estate comprising the cryptocurrency sum, a party to a financial transaction comprising a transfer of the cryptocurrency sum, etc. In some examples, the custodian and/or third party may include an insurer of the cryptocurrency sum, a trustee of a trust comprising the cryptocurrency sum, an executor of an estate comprising the cryptocurrency sum, etc.

The operations 200 may further include determining whether a transaction time of the cryptocurrency transaction instruction is in at least one predetermined time period of a plurality of predetermined time periods (Block 204). In this example, the transaction time may not be included as part of the transaction instruction, and may instead be determined based on a time of receipt of the instruction by the processor circuit. In this example, each predetermined time period corresponds to a predetermined subset of authorized keysets.

The operations 200 may further include, for each time period, determining whether the at least one key in the transaction instruction comprises at least one key from each keyset of the predetermined subset of authorized keysets corresponding to the at least one predetermined time period (Block 206). For example, there may be four predetermined time periods in this example, corresponding to an insurance policy term, a compliance period following the policy term, a compromised asset recovery period, and a customer recovery period, each with its own subset of authorized keysets.

In this example, if the transaction time is in a first predetermined time period, the operations 200 may include determining whether the at least one key comprises a first subset of keys (Block 208). In this example, this may include determining whether that the at least one key comprises a first minimum number of customer keys of the at least one customer keyset, second minimum number of custodian keys of the at least one custodian keyset, and third minimum number of third party keys of the at least one third party keyset

In this example, if the transaction time is in a second predetermined time period, the operations 200 may include determining whether the at least one key comprises a second subset of keysets (Block 210). In this example, this may include determining whether the at least one key comprises a fourth minimum number of customer keys smaller than the first minimum number of customer keys, a fifth minimum number custodian keys, and a sixth minimum number of third party keys.

In this example, if the transaction time is in a third predetermined time period, the operations 200 may include determining whether the at least one key comprises a third subset of keysets (Block 212). This may include determining whether the at least one key comprises a sixth minimum number of custodian keys and a seventh minimum number of third party keys.

In this example, if the transaction time is in a fourth predetermined time period, the operations 200 may include determining whether the at least one key comprises a fourth subset of keysets (Block 214). This may include determining whether the at least one key comprises an eighth minimum number of customer keys.

It should be understood that many different examples and combinations may be used, and that the use of ordinal numbers, i.e., first, second, etc., above and throughout the present disclosure for times, time periods, keys, keysets, and other elements does not imply or require that the numbers or associated elements be arranged or occur in a particular order. It should also be understood that the values of different elements are not necessarily different from one another unless specifically stated. For example, in the embodiment of FIG. 2, the eighth minimum number of customer keys may be equal to or different from the first minimum number of customer keys, may also be equal to or different from the fourth minimum number of customer keys, so long as the fourth minimum number of customer keys is smaller than the first minimum number of customer keys.

The operations 200 may further include, in response to a determination that the at least one keyset comprises the subset of authorized keysets corresponding to the respective time period, executing the second cryptocurrency transaction (Block 216).

The operations 200 may further include in response to a determination that the at least one keyset does not comprise the entire subset of authorized keysets corresponding to the respective time period, rejecting the second cryptocurrency transaction (Block 218). In some embodiments, an alert indication, e.g., an alarm, a notification, and/or a lockout instruction for example, may also be transmitted to at least one authorized keyset of the plurality of authorized keysets, and/or to a third party. In some embodiments all future cryptocurrency transactions requests may be automatically rejected for a predetermined time period. This may be implemented, for example, by an internal process by an insurer or third party, where access to the insurer keyset and/or third party keyset may be automatically restricted for the predetermined time period if suspicious activity is detected, so that the conditions for the relevant authentication layer(s) cannot be met during that time.

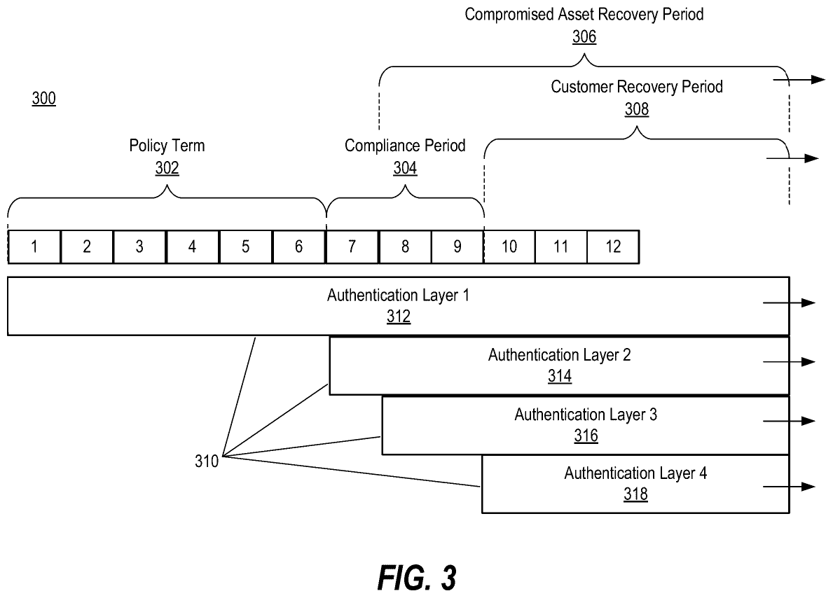

FIG. 3 is a graphical timeline 300 of time periods for an insurance policy term and a period following expiration of the policy with different time periods generally corresponding to the example of FIG. 2. For example, an insurance policy may specify a six month term 302, with a three-month compliance period 304 beginning at the expiration of the policy term 302. For example, the compliance period 304 is may be useful for providing a reasonable amount of time after the policy has ended and the claims window has closed, and after the insurer no longer has liability, to continue to secure the cryptocurrency funds against unauthorized activity.

A two month compromised asset recovery period 306 may also begin one month after the expiration of the policy term 302 and may run concurrently through the remainder of the compliance period 304 and may continue indefinitely, as desired, as an additional layer of security and recovery. Finally, after the completion of the compliance period 304, a customer recovery period 308 begins and continues indefinitely. It should be understood that the durations of any of these periods may be selected and/or modified by the parties, as desired. For example, the policy term 302 may have any duration, e.g., one month, one year, three years, etc.

The vault contains a number of time-locked authentication layers 310 corresponding to the time periods associated with the policy, and keysets and keyset provision criteria may be independently configured for each authentication layer 310, as desired. In this example, the policy term 302 corresponds to a first authentication layer 312 that is time locked to be available at the beginning of the policy term 302. In this example, during the time period that the first authentication layer 312 is active, i.e., at any time after creation of the vault 300, cryptocurrency funds in the vault can be accessed by providing a customer keyset, an insurer keyset, and a third party keyset.

A second authentication layer 314 corresponds to the three-month compliance period 304 and becomes active at the beginning of the compliance period 304. In this example, during the time period that the second authentication layer 314 is active, the cryptocurrency funds in the vault can be accessed by providing the customer keyset, e.g., any one of the three customer keys in this example, the insurer keyset, and the third party keyset.

A third authentication layer 316 corresponds to the two-month compromised asset recovery period 306 and becomes active at the beginning of the compromised asset recovery period 306. In this example, during the time period that the third authentication layer 316 is active, cryptocurrency funds in the vault can be accessed by providing the insurer keyset and the third party keyset. This option is provided in the event that the customer's keyset becomes lost or damaged.

A fourth authentication layer 318 corresponds to the customer recovery period 308 and becomes active at the beginning of the customer recovery period 308. In this example, during the time period that the fourth authentication layer 318 is active, cryptocurrency funds in the vault can be accessed by providing the customer keyset, e.g., any two of the three customer keys in this example, and the customer can now independently move the now-uninsured funds out of the vault without any involvement from the insurer or the third party.

In this example, all layers 310 being independently accessible while they are active, and each authentication layer 310 remains active indefinitely after activation, such that multiple authentication layers 310 can be active and accessible at the same time. For example, after the customer recovery period 308 begins and the fourth authentication layer 318 is activated, the first activation layer 312 remains active even though the policy term 310 is expired, but the fourth activation layer 318 renders the additional requirements of the first activation layer 312 superfluous. This arrangement also allows for activation layers 310 to have independent, mutually exclusive requirements, as an added layer of security against loss or damage of the customer keyset. For example, even after the customer recovery period 308 begins and the fourth activation layer 318 becomes active, the third activation layer 316, which is accessible by the insurer keyset and the third party keyset without the customer keyset, remains available in the case of catastrophic loss of the customer keyset.

While the activation layers 310 do not expire in this embodiment, restrictions on the transfer of funds may be reimposed by transferring the funds to a new vault with a new set of time locked authentication layers. For example, if the customer wishes to renew a policy at the conclusion of the policy term 308, a new vault may be created with the same time locked authentication layers, with new start times based on the commencement of the policy term renewal, and the funds can be transferred from the original vault 300 to the new vault. In some embodiments, authentication layers may be added, removed, and/or modified as desired when creating the new vault. It should also be understood that, in some embodiments, a vault may be created with authentication layers that may have a start time and an end time, where the authentication layer may not be accessible before the start time or after the end time, as desired.

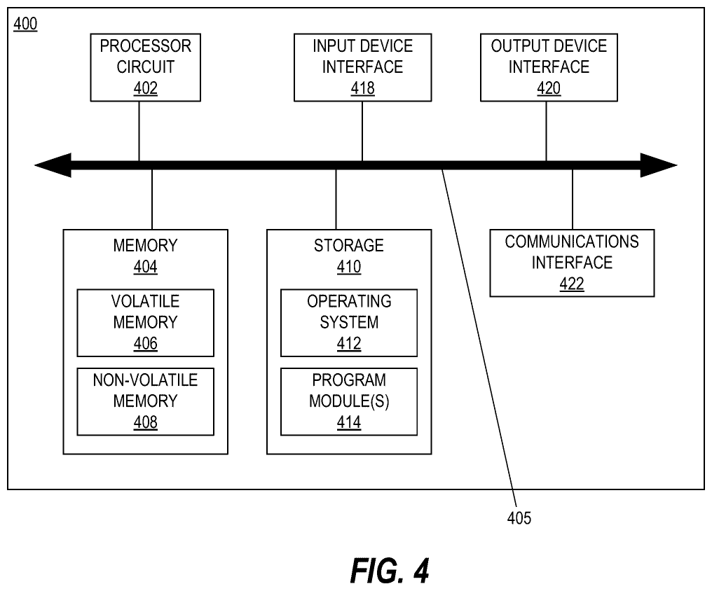

FIG. 4 is a schematic diagram of a computer system 400 for implementing embodiments disclosed herein. The computer system 400 is adapted to execute instructions from a computer-readable medium to perform these and/or any of the operations or processing described herein. The computer system 400 may be connected to other devices in a network, as desired. While only a single device is illustrated, the computer system 400 may include any collection of devices that individually or jointly execute instructions to perform any one or more of the operations discussed herein.

The computer system 400 may include a processor circuit 402, a memory 404, and a system bus 405 providing an interface for system components. The processor circuit 402 may, for example, include a general-purpose processor, an application specific processor, an Application Specific Integrated Circuit (ASIC), a group of distributed computers and/or processing components, or any combination thereof. The processor circuit 402 may further include computer executable code that controls operation of the computing device.

The memory 404 may be one or more devices for storing data and/or computer code for completing or facilitating operations described herein. The memory 404 may be connected to the processor circuit 402 via a system bus 405 and may include computer code for executing one or more processes described herein. The memory 404 may include non-volatile memory 406 (e.g., read-only memory (ROM), erasable programmable read-only memory (EPROM), etc.), and volatile memory 408 (e.g., random-access memory (RAM)), or any other medium which can be used to store desired program code in the form of machine-executable instructions or data structures, and which can be accessed by a computer or other machine with a processor circuit 402.

The computer system 400 may further include or be coupled to a non-transitory computer-readable storage medium such as the storage device 410, which may comprise, for example, an internal or external hard disk drive (HDD) for non-volatile storage of data, data structures, computer-executable instructions, etc.

Computer code may be provided in the form of one or more modules. The module(s) can be implemented as software and/or hard coded in circuitry to implement the operations described herein in whole or in part. The modules may be stored in the storage device 410 and/or in the volatile memory 408, which may include an operating system 412 and/or one or more program modules 414, such as program modules configured to cause the processor circuit 402 to execute one or more operations for example. All or a portion of the examples disclosed herein may be implemented as a computer program stored on the storage device 410 or any other transitory or non-transitory computer-readable storage containing machine-readable instructions that, when executed by the processor circuit 402, cause the processor circuit 402 to perform operations described herein, such as one or more of the operations 200 described above with respect to FIG. 2 for example.

The computer system 400 may include an input device interface 418 configured to receive input and selections to be communicated to the computer system 400 when executing instructions, such as from a keyboard, mouse, touch-sensitive surface, etc. Such input devices may be connected to the processor circuit 402 through the input device interface 418 coupled to the system bus 405 but can be connected through other wired and/or wireless interfaces, as desired. The computer system 400 may include an output device interface 420 configured to forward output, such as to a display. The computer system 400 may include a communications interface 422 suitable for communicating with a network and/or other devices as desired.

The terminology used herein is for the purpose of describing particular examples and embodiments and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the examples and embodiments described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation.

What is claimed is:

1. A system comprising:
at least one processor circuit; and
at least one memory comprising machine-readable instructions that, when executed by the at least one processor circuit, cause the at least one processor circuit to:
execute a first cryptocurrency transaction to transfer a cryptocurrency sum to a cryptocurrency vault, the cryptocurrency vault comprising a plurality of predetermined subsets of a plurality of authorized keysets, each keyset comprising at least one key;
receive a cryptocurrency transaction instruction to execute a second cryptocurrency transaction to transfer at least a portion of the cryptocurrency sum out of the cryptocurrency vault, the cryptocurrency transaction instruction comprising at least one key associated with at least one authorized keyset of the plurality of authorized keysets;
determine whether a transaction time of the cryptocurrency transaction instruction is in at least one predetermined time period of a plurality of predetermined time periods, each predetermined subset corresponding to a predetermined subset of authorized keysets of a plurality of predetermined subsets of the plurality of authorized keysets;
determine whether the at least one key in the transaction instruction comprises at least one key from each keyset of the predetermined subset of authorized keysets corresponding to the at least one predetermined time period; and
in response a determination that the at least one key in the transaction instruction comprises at least one key from each keyset of the predetermined subset of authorized keysets corresponding to the at least one predetermined time period, execute the second cryptocurrency transaction.

2. The system of claim 1, wherein the instructions further cause the at least one processor circuit to, in response a determination that the at least one key in the transaction instruction does not comprise at least one key from each keyset of the predetermined subset of authorized keysets corresponding to the at least one predetermined time period, reject the second cryptocurrency transaction.

3. The system of claim 2, wherein the instructions further cause the at least one processor circuit to, in response to a determination that the at least one key in the transaction instruction does not comprise at least one key from each keyset of the predetermined subset of authorized keysets corresponding to the at least one predetermined time period, transmit an alert indication to at least one authorized keyset of the plurality of authorized keysets.

4. The system of claim 1, wherein the plurality of authorized keysets comprises at least one customer keyset associated with a customer, at least one custodian keyset associated with a custodian of the cryptocurrency vault, and at least one third party keyset associated with a third-party.

5. The system of claim 4, wherein a determination that the at least one key in the transaction instruction comprises at least one key from each keyset of the predetermined subset of authorized keysets corresponding to a first predetermined time period comprises a determination that the at least one key comprises a first minimum number of customer keys of the at least one customer keyset, second minimum number of custodian keys of the at least one custodian keyset, and third minimum number of third party keys of the at least one third party keyset.

6. The system of claim 5, wherein a determination that the at least one key in the transaction instruction comprises at least one key from each keyset of the predetermined subset of authorized keysets corresponding to a second predetermined time period beginning after the first predetermined time period comprises a determination that the at least one key comprises a fourth minimum number of customer keys.

7. The system of claim 6, wherein a determination that the at least one key in the transaction instruction comprises at least one key from each keyset of the predetermined subset of authorized keysets corresponding to a third predetermined time period beginning after the first predetermined time period and before the second predetermined time period comprises a determination that the at least one key comprises a fifth minimum number of customer keys smaller than the first minimum number of customer keys, a sixth minimum number custodian keys, and a seventh minimum number of third party keys.

8. The system of claim 6, wherein a determination that the at least one key in the transaction instruction comprises at least one key from each keyset of the predetermined subset of authorized keysets corresponding to a third predetermined time period after the first predetermined time period and before the second predetermined time period comprises a determination that the at least one key comprises a fifth minimum number of custodian keys and a sixth minimum number of third party keys.

9. The system of claim 4, wherein the at least one third party comprises an insurer of the cryptocurrency sum.

10. The system of claim 4, wherein the at least one third party comprises a trustee of a trust comprising the cryptocurrency sum, and wherein the at least one customer comprises a beneficiary of the trust.

11. The system of claim 4, wherein the at least one third party comprises an executor of an estate comprising the cryptocurrency sum, and wherein the at least one customer comprises a beneficiary of the estate.

12. The system of claim 4, wherein the cryptocurrency vault comprises an escrow account, wherein the at least one custodian comprises an escrow agent, and wherein the at least one customer and the at least one third party comprise parties to a financial transaction comprising a transfer of the cryptocurrency sum.

13. The system of claim 1, wherein the cryptocurrency sum comprises Bitcoin, and wherein the first cryptocurrency transaction and the second cryptocurrency transaction comprise Bitcoin transactions.

14. The system of claim 1, wherein the cryptocurrency sum comprises Ethereum, and wherein the first cryptocurrency transaction and the second cryptocurrency transaction comprise Ethereum transactions.

15. A method comprising:
receiving, by at least one processor circuit, a cryptocurrency transaction instruction to execute a cryptocurrency transaction to transfer at least a portion of the cryptocurrency sum out of a cryptocurrency vault, the cryptocurrency transaction instruction comprising at least one key associated with at least one authorized keyset of a plurality of authorized keysets;
determining, by the processor circuit, whether a transaction time of the cryptocurrency transaction instruction is in at least one predetermined time period of a plurality of predetermined time periods, each predetermined subset corresponding to a predetermined subset of authorized keysets of a plurality of predetermined subsets of the plurality of authorized keysets;
determining, by the processor circuit, whether the at least one key in the transaction instruction comprises at least one key from each keyset of the predetermined subset of authorized keysets corresponding to the at least one predetermined time period;
executing, by the processor circuit, the cryptocurrency transaction only in response a determination that the at least one key in the transaction instruction comprises at least one key from each keyset of the predetermined subset of authorized keysets corresponding to the at least one predetermined time period.

16. The method of claim 15, wherein the plurality of authorized keysets comprises at least one customer keyset associated with a customer, at least one custodian keyset associated with a custodian of the cryptocurrency vault, and at least one third party keyset associated with a third-party,
wherein determining that the at least one key in the transaction instruction comprises at least one key from each keyset of the predetermined subset of authorized keysets corresponding to a first predetermined time period comprises determining that the at least one key comprises a first minimum number of customer keys of the at least one customer keyset, second minimum number of custodian keys of the at least one custodian keyset, and third minimum number of third party keys of the at least one third party keyset, and
wherein determining that the at least one keyset comprises the predetermined subset of authorized keysets for a second predetermined time period after the first predetermined time period comprises determining that the at least one key comprises the first minimum number of customer keys of the plurality of authorized customer keys.

17. The method of claim 15, wherein the cryptocurrency sum comprises Bitcoin, and wherein the first cryptocurrency transaction and the second cryptocurrency transaction comprise Bitcoin transactions.

18. A non-transitory computer readable medium comprising machine readable instructions that, when executed by at least one processor circuit, cause the at least one processor circuit to:
receive a cryptocurrency transaction instruction to execute a cryptocurrency transaction to transfer at least a portion of the cryptocurrency sum out of a cryptocurrency vault, the cryptocurrency transaction instruction comprising at least one key associated with at least one authorized keyset of a plurality of authorized keysets;
determine whether a transaction time of the cryptocurrency transaction instruction is in at least one predetermined time period of a plurality of predetermined time periods, each predetermined subset corresponding to a predetermined subset of authorized keysets of a plurality of predetermined subsets of the plurality of authorized keysets;
determine whether the at least one key in the transaction instruction comprises at least one key from each keyset of the predetermined subset of authorized keysets corresponding to the at least one predetermined time period; and
in response a determination that the at least one key in the transaction instruction comprises at least one key from each keyset of the predetermined subset of authorized keysets corresponding to the at least one predetermined time period, execute the second cryptocurrency transaction.

19. The computer readable medium of claim 18, wherein the instructions further cause the at least one processor circuit to, in response a determination that the at least one key in the transaction instruction does not comprise at least one key from each keyset of the predetermined subset of authorized keysets corresponding to the at least one predetermined time period, reject the cryptocurrency transaction.

20. The computer readable medium of claim 18, wherein the plurality of authorized keysets comprises at least one customer keyset associated with a customer, at least one custodian keyset associated with a custodian of the cryptocurrency vault, and at least one third party keyset associated with a third-party,
wherein a determination that the at least one key in the transaction instruction comprises at least one key from each keyset of the predetermined subset of authorized keysets corresponding to a first predetermined time period comprises a determination that the at least one key comprises a first minimum number of customer keys of the at least one customer keyset, second minimum number of custodian keys of the at least one custodian keyset, and third minimum number of third party keys of the at least one third party keyset, and
wherein a determination that the at least one key in the transaction instruction comprises at least one key from each keyset of the predetermined subset of authorized keysets corresponding to a second predetermined time period beginning after the first predetermined time period comprises a determination that the at least one key comprises a fourth minimum number of customer keys.
